(19) United States
(12) Patent Application Publication
(10) Pub. No.: US 2010/0106416 A1
(43) Pub. Date: Apr. 29, 2010

(54) AIRCRAFT NAVIGATION USING THE GLOBAL POSITIONING SYSTEM, INERTIAL REFERENCE SYSTEM, AND DISTANCE MEASUREMENTS

(76) Inventor: Thomas E. Yochum, Kirkland, WA (US)

Correspondence Address: QUARLES & BRADY LLP, 411 E. WISCONSIN AVENUE, SUITE 2040, MILWAUKEE, WI, 53202-4497, US

(21) Appl. No.: 12/259,489

(22) Filed: Oct. 28, 2008

(51) Int. Cl. G01C 21/00; G06F 17/00

(52) U.S. Cl. 701/213; 707/E17.125

(57) ABSTRACT

A navigation technique for a vehicle employs an inertial reference system to derive a first position indication and a first velocity value. A first receiver processes signals of a global positioning system from which a second position indication and a second velocity value are derived. A second receiver processes signals from a plurality of distance measuring equipment stations at fixed positions on the earth and determines the distance between the vehicle and each of those stations. A third position indication is derived from those distances. A Kalman filter function is applied to the first, second and third position indications and to the first and second velocity values to compensate for uncertainty in the first position indication and in the first velocity value and thereby produce a vehicle position estimate and a vehicle velocity estimate.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to navigation and positioning systems, and more particularly to navigation utilizing the global positioning system, inertial reference system, or distance measuring equipment.

2. Description of the Related Art

Aircraft have traditionally used an inertial reference system (IRS) with motion sensors connected to a processor that continuously tracked the position, orientation, and velocity (direction and speed) of the aircraft without using external references. The inertial reference system was initialized on the ground by the flight crew entering the position coordinates of the aircraft, such as the longitude, latitude and altitude of the airport at which the aircraft is parked. As the aircraft moved thereafter, the inertial reference system updated the position and velocity by integrating information received from the motion sensors on the aircraft. The motion sensors usually included three accelerometers that measured linear acceleration along three orthogonal axes, and a trio of gyroscopes that measured angular velocity along the three axes. The aircraft velocity and change in position was derived from the accelerometer and gyroscope signals. The change in position along with a previously determined position are employed to derive a new position for the aircraft.

All inertial reference systems suffer from integration drift, which are small errors in the measurement of acceleration and angular velocity that become integrated into progressively larger velocity and position errors. Thus, over the course of a trip, the inertial reference system's indication of position can deviate from that actual position of the aircraft.

Because of that drift, present day inertial reference systems are corrected by data from the global positioning system (GPS). The GPS uses a constellation of earth orbiting satellites that continuously transmit messages via microwave signals containing the time at which the message was sent and ephemeris data regarding the precise orbit for the satellite. A GPS receiver onboard the aircraft uses the arrival time of each message, the time it was sent, and the propagation rate of the microwave signal, to calculate the separation distance between the aircraft and the satellite. The location of the satellite is determined from its ephemeris data. This information tells the GPS receiver that the aircraft is located on an imaginary spherical surface centered at the satellite and having a radius equal to the separation distance. Using similar data from a second satellite, the GPS receiver determines that the aircraft also is located on a second imaginary spherical surface and more specifically on the circular intersection of the two spherical surfaces. The spherical surface related to a third satellite intersects the circle at two points, only one of which often is a possible location for the aircraft as the other point may be too far from the earth. Nevertheless, the data from a fourth satellite eliminates one of those two points, confirming the precise location of the aircraft. The three dimension GPS position then was used to correct the drift error of the inertial reference system.

However, if GPS signals from a sufficient number of satellites were not received, the inertial reference system drift error no longed could be dynamically corrected. For example, atmospherical and astronomical conditions adversely affect the reception of GPS signals. If the GPS information is lost, the accuracy of the inertial reference system degraded over time.

General aviation pilots have often utilized distance measuring equipment and VHF omni-directional radio range equipment as tools for manual navigation. The distance measuring equipment (DME) is a transponder-based radio system that consists of a plurality of ground-based transponder stations that are interrogated by a radio transceiver onboard the aircraft. Each ground station has an assigned radio frequency on which the onboard aircraft transceiver transmits a series of interrogation pulse-pairs. Upon receiving an interrogation pulse-pair, the ground-based transponder delays precisely 50 microseconds and then transmits a similar pulse-pair on an associated reply frequency. When the interrogation transceiver onboard the aircraft receives a pulse-pair, it calculates the elapsed time between the transmission of its pulse-pair and the receipt of the reply pulse-pair. The 50 microsecond delay is subtracted from that elapsed time resulting in a time interval equal to twice the propagation time for the radio signal to travel one-way between the aircraft and the ground transponder. Utilizing the propagation rate of the radio signal and the one-way propagation time, the onboard interrogation transceiver determined the distance that the aircraft was from the ground station.

The DME system measures the direct distance between the aircraft and the ground station which due to the altitude of the aircraft, differs from the horizontal or earth's surface distance to the ground station. That difference is referred to as a slant range error. For example, if the aircraft is horizontally four miles from the ground transponder and is at an altitude of three miles, the distance measuring equipment will indicate a spacing of five miles, i.e. the hypotenuse of the right triangle formed by the horizontal and vertical distances. This slant range error increases as an aircraft gets closer to the ground transponder. For example, if an aircraft is slightly more than 10,000 feet directly above the transponder, the onboard DME transceiver will indicate a distance of approximately two miles even though the horizontal distance is zero. Furthermore, the signal frequencies used, limit the DME system to interrogating transponders located on a line of sight with the aircraft and thus has a limited range due to the earth curvature.

DME transponder stations are often co-located with a VHF omni-directional range (VOR) radio station in order for the aircraft to determine not only the distance from the station, but also a bearing from the station to the aircraft. A VOR facility transmits two signals at the same time. One signal is constant in all directions, while the other is rotated about the station. The aircraft equipment receives and electronically determines the difference between the two signals, and interprets the result as a radial from the station. This provides a bearing from the station to the aircraft.

### SUMMARY OF THE INVENTION

A navigation system for a vehicle comprises an inertial reference system onboard the vehicle which provides a first set of data from which is produced a first position indication. A first receiver, onboard the vehicle, processes signals of a global positioning system and produces a second set of data from which a second position indication is produced. A second receiver, onboard the vehicle, receives signals from a plurality of distance measuring equipment stations at fixed positions on the earth and in response thereto produces a third set of data denoting distances between the vehicle and each distance measuring equipment station, from which third set of data a third position indication is produced.

A processor employs the second and third position indications to compensate for uncertainty in the first position indication and thereby produce a position estimate. Preferably the processor applies a recursive data processing algorithm, such as a Kalman filter function, to the first, second, and third position indications to produce the position estimate.

In a preferred embodiment of the navigation system, the first set of data from the first receiver also is employed to produce a first velocity value and the second set of data from the second receiver also is employed to produce a second velocity value. The processor utilizes the second velocity value to compensate for uncertainty in the first velocity value and thereby produce a velocity estimate. Here too, the processor preferably applies a Kalman filter function to produce the velocity estimate.

### BRIEF DESCRIPTION OF THE DRAWINGS

FIG. 1 is a diagrammatic depiction of an operational scenario for an aircraft that utilizes the present invention;

FIG. 2 is a schematic diagram of the onboard system for determining the position of the aircraft;

FIG. 3 is a flowchart of a software routine for determining the position of the aircraft using signals from distance measuring equipment;

FIG. 4 is a flowchart of software that applies a Kalman filter to compensate for inaccuracy of inertial reference data; and

FIG. 5 is a definition of the state and control vectors of the Kalman filter.

### DETAILED DESCRIPTION OF THE INVENTION

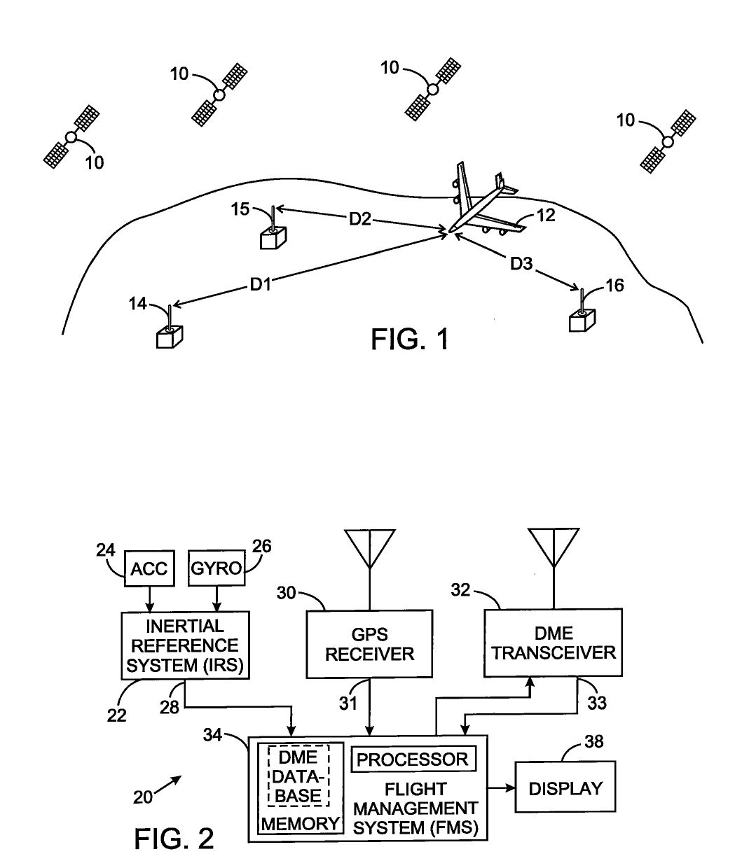

Referring initially to FIG. 1, the conventional global positioning system (GPS) comprises a plurality of satellites 10, each broadcasting a unique microwave signal. Those GPS signals from the satellites 10 can be used to determine the position of a vehicle, such as the aircraft 12. The orbits of the GPS satellites 10 are arranged in multiple planes, in order to maximize the likelihood that the aircraft 12 simultaneously receives signals from at least four GPS satellites at any arbitrary point on or near the earth. The orbits of the GPS satellites 10 are determined with accuracy from fixed ground stations and are relayed back to the respective satellite.

In navigation applications of the GPS, the latitude, longitude, and altitude of any point close to the earth, such as that of the aircraft 12, can be calculated from the propagation times of the signals from four or more of the satellites 10 to the unknown location. A measured range, often called the “pseudorange”, between the GPS receiver at the unknown location and the four satellites within view is determined based on those propagation times. The measured range is referred to as pseudorange because there is generally a time difference or offset between timing clocks on the satellites and a timing clock within the GPS receiver. Thus, for three-dimensional position determination at least four satellite signals are typically needed to solve for four unknowns, i.e., the time-offset together with the three-dimensional position. The present navigation technique employs the global positioning system in a conventional manner to provide one determination of the position of the aircraft 12.

There also are a plurality of conventional distance measuring equipment (DME) ground stations 14, 15 and 16 at different known locations on the earth. As will be described in detail, a DME transceiver onboard the aircraft 12 sequentially interrogates the DME transponders at a plurality of ground stations 14-16 and conventionally determines the distance between the aircraft and each station based on the propagation delay between when the interrogation request was sent and when a rely is received.

Referring to FIG. 2, the navigation system 20 onboard the aircraft 12 is built around a flight management system (FMS) 34 that is a computerized avionics component similar to ones found on most commercial and business aircraft to assist pilots in navigation, flight planning, and aircraft control functions. The FMS 34 includes a processor that integrates the functions of navigation and aircraft performance management. The processor is coupled to a memory contains a database of navigation data for airports, approach and departure procedures, airways, holding patterns and other information. The present flight management system 34 receives information derived from the GPS satellites 10 and the DME ground stations 14-16 and has been upgraded with the addition of software routines and data necessary used that information in implementing the present invention.

Connected to the FMS 34 is a conventional inertial reference system 22 which receives input signals from three accelerometers 24 that measure acceleration along three axes and three gyroscopes 26 for measuring angular motion relative to a reference plane. The inertial reference system 22 converts the data from the accelerometers and gyroscopes to determine an inertial position indication in the World Geodetic System of 1984 (WGS-84) coordinate system, which is an earth-centered, earth-fixed reference frame. Nevertheless another coordinate system may be used. The inertial reference system 22 also produces an aircraft velocity value. The aircraft position indication and velocity value are produced at an output 28 that is connected to the FMS 34.

The navigation system 20 also includes a GPS receiver 30 that processes signals from several GPS satellites 10 orbiting the earth and from those signals derives a position for the aircraft, in a conventional manner. From those satellite signals, the GPS receiver 30 produces an aircraft position indication and a velocity value at output 31 coupled to the FMS 34. The GPS system also utilizes the WGS-84 coordinate system.

A distance measuring equipment (DME) transceiver 32 is included in the navigation system 20 to provide additional position data to the flight management system 34. For that purpose, the FMS 34 has been provided with additional software to identify several DME transponder stations in the vicinity of the aircraft and then sequentially tune the DME transceiver 32 to each of those stations. This procedure provides a series of measurements of the distances between the aircraft and those nearby DME transponder stations.

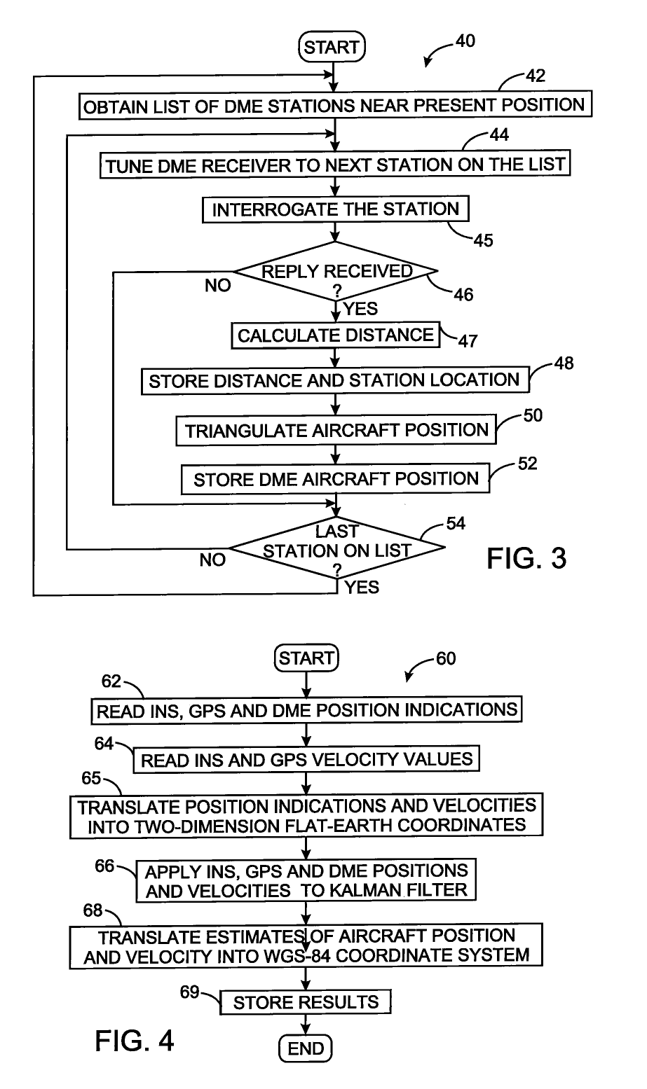

FIG. 3 is a flowchart of a software routine 40 by which the FMS 34 interacts with the DME transceiver 32 to determine a position indication for the aircraft. The routine commences at step 42 where the FMS processor queries the onboard DME database of the locations for the DME stations within a given geographical region, such as North America. The FMS utilizes a previously determined position of the aircraft to obtain a list of up to 16 DME stations within the line of sight of the aircraft, however any number of three or more stations may be used. The data obtained for each of those DME stations, includes its geographical location and interrogation radio frequency. Then at step 44, the FMS tunes the DME transceiver 32 to the first station on the list which at step 45 causes the transmitter section to send an interrogation signal to the selected station and the receiver section to receive the reply signal. Occasionally a reply is not received from a DME station and step 56 determines whether that is the case. If so, the routine jumps to step 54 to proceed to another station.

When a reply is received, the DME transceiver 32 at step 47 employs the time at which its interrogation signal was transmitted and the time at which the reply signal was received to determine the distance to the respective DME station. It may take several seconds to interrogate a DME station, receive a reply, and calculate the associated distance Dx, where x is a number identifying a particular DME station. For example, FIG. 1 depicts the distance measurements D1, D2 and D3 for three DME stations 14, 15 and 16. The newly derived distance and location for a DME station are stored at step 48 in a section of the memory of the FMS 34 reserved for that data.

At step 50 that new data along with previously derived distance and location data for other nearby DME stations are processed to determine the current position of the aircraft 12. The location of each DME station and the distance therefrom to the aircraft are utilized in a triangulation process to trigonometrically determine the position of the aircraft in the WGS-84 coordinate system. That position indication is then stored in the FMS memory at step 52. The DME position determination routine 40 then terminates until the next execution time. Thereafter, a determination is made by the FMS at step 54, whether all the DME stations on the list have been interrogated and, if not, the execution of the DME position determination routine 40 returns to step 44 to interrogate the next station on the list. When all the listed stations have been interrogated, the execution branches from step 54 to step 42 to query the DME database to add and delete stations to the list based on the change in the position of the aircraft before interrogating another station.

The flight management system 34 employs the position indications from the GPS receiver 30 and the DME transceiver 32 to compensate the position determination from the inertial reference system 22 for inherent drift errors. Specifically, FIG. 4 represents a flowchart of an IRS compensation routine 60 that is executed by the processor in the flight management system. Periodically at step 62, the FMS processor reads the position indications provided by each of the inertial reference system 22, GPS receiver 30, and DME transceiver 32. Then at step 64, the velocity values produced by the inertial reference system 22 and the GPS receiver 30 are read by the FMS processor.

At step 65, the processor in the FMS 34 then converts the sets of position indications and velocity values from the WGS-84 coordinate system into corresponding parameters in a two-dimension, flat-earth Cartesian coordinate system in which altitude has been removed. This results in the parameters from the inertial reference system 22 being expressed as an aircraft position indication, IRSₚₓ and IRS_{py}, and a velocity value, IRSᵥₓ and IRS_{vy}. Similarly the GPS aircraft position indication is expressed as GPSₚₓ and GPS_{py} and the aircraft velocity value as GPSᵥₓ and GPS_{vy}. The two-dimensional position indication from the DME system is given as DMEₚₓ and DME_{py}.

That position and velocity data are applied to a Kalman filter at step 66. The Kalman filter is an efficient recursive data processing algorithm that estimates the state of a dynamic system from a series of measurements, each of which may, at least from time to time, have some degree of inaccuracy or uncertainty. The Kalman filter combines the position and velocity measurement data from the three subsystems 22, 30 and 32, plus prior knowledge about the aircraft dynamics, to produce an estimate of the aircraft position and velocity in a manner that statistically minimizes uncertainty present in the input data. This means that only the estimated previous position and velocity along with current measurements are needed to derive an estimate for the current position and velocity of the aircraft.

In the Kalman filter, dynamics of the system are modeled mathematically using either a continuous-time or discrete update equation. The discrete state equation has the form:

x(k+1)=A*x(k)+B*u(k)+w(k)

### Where:

x(k) is the state vector (truth) at time k,
A is the state transition matrix (STM),
B is the control matrix,
u(k) is the control vector at time k, and
w(k) is the process noise vector affecting accuracy at time k.
   This equation provides the prediction aspect of the Kalman filter. Next, sensors make either direct or indirect measurements of the states. The relationship between the state vector and the measurements is given by:

Z(k)=H*x(k)+v(k)

### Where:

Z(k) is the measurement vector at time k,
H is the measurement connection matrix, and
v(k) is the measurement noise vector at time k.

Kalman filtering assumes that process and measurement noise is normally distributed white noise that can be expressed as:

p(w>=N(O,Q)

p(v>=N(0,R)

### Where:

p(w) is the probability of vector w, and
N(0,Q) is a normally-distributed random number vector with zero mean and covariance matrix Q.
   The Kalman filter is implemented with non-white process and measurement noise by adding extra states.

Finally, each state is statistically related to the other states through the covariance matrix P. The matrix P is defined by:

\hat{x}(k)=E[x(k)]

P(k)=E[(x(k)−\hat{x}(k))*(x(k)−\hat{x}(k))^{T}]

### Where:

\hat{x}(k) is the estimated state vector at time k,
E[ ] is the expected value function, and
P(k) is the state covariance matrix.
   The state corrector uses measurement data to drive the state estimate (\hat{x}(k)) towards the actual state value (x(k)). Rudolf E. Kalman proved that the following set of equations guarantee asymptotic convergence of the state estimate to the actual state while minimizing the state covariance matrix.

Estimation Step:

\hat{x}⁻(k+1)=A*\hat{x}(k)+B*u(k)

P⁻(k+1)=A*P(k)*A^{T}+Q

Correction Step:

K=P⁻(k+1)*(H*P⁻(k+1)*H^{T}+R)⁻¹

\hat{x}(k+1)=\hat{x}⁻(k+1)+K*(Z(k)−H*\hat{x}⁻(k+1))

P(k+1)=(I−K*H)*P⁻(k+1)

### Where:

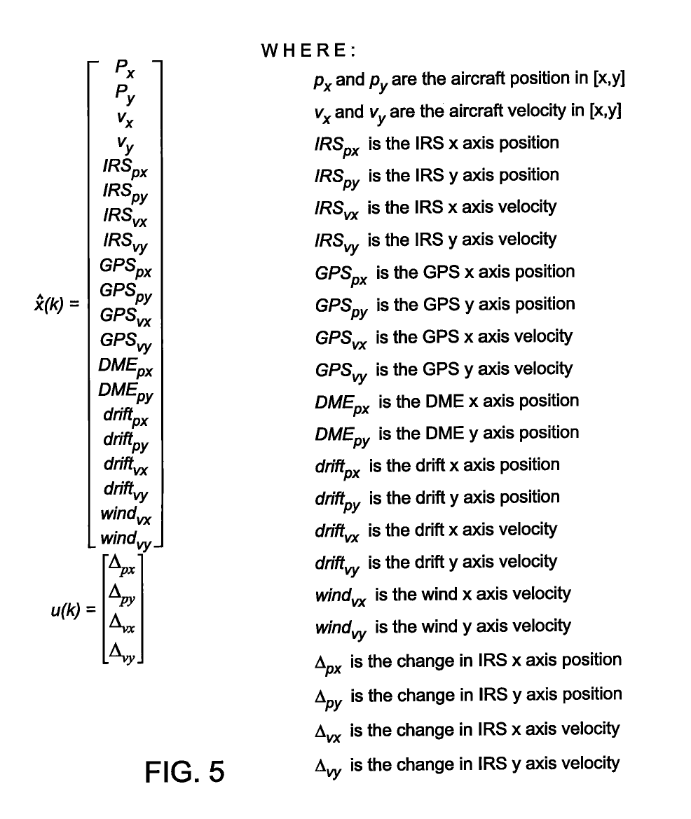

\hat{x}⁻ is the uncorrected state estimate,
P⁻ is the uncorrected state covariance matrix,
K is the Kalman gain matrix, and
I is the identity matrix.
   A flat-earth Cartesian coordinate system is used. The state and control vectors for the Kalman filter are defined as depicted in FIG. 5. The drift and wind are intermediate terms generated by the filter function. Internally the Kalman filter function produces an approximation of the velocity from the change in position indicated by successive DME position indications.

At step 68, the resultant estimated position Px and Py and estimated velocity Vx and Vy produced by the Kalman filter are converted from the two-dimension, flat-earth Cartesian coordinate system into the WGS-84 coordinate system. The estimated position and the estimated velocity of the aircraft then at step 69 are stored within the flight management system 34 in FIG. 2 and may be presented to the flight crew via the cockpit display 38.

The present invention derives three position indications from the inertial reference system 22, the GPS receiver 30, and the DME transceiver 32. The Kalman filter exploits the dynamics of the aircraft which govern its time evolution, to remove the effects of system uncertainty from that trio of position indications and provides optimal estimates of the present aircraft location and velocity. The basic position and velocity indications from the inertial reference system 22 are adjusted based on the position indication from the GPS receiver 30, however if that GPS data becomes unreliable or unavailable the position indication from the DME transceiver 32 provides compensation to the IRS indications.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A navigation system for a vehicle comprising:
an inertial reference system onboard the vehicle and producing a first set of data from which a first position indication is produced;
a first receiver, onboard the vehicle, for signals of a global positioning system and producing a second set of data from which a second position indication is produced;
a second receiver, onboard the vehicle, for receiving signals from a plurality of distance measuring equipment stations located at fixed positions on the earth and in response thereto producing a third set of data denoting distances between the vehicle and each distance measuring equipment station, from which third set of data a third position indication is produced; and
a processor that employs the second and third position indications to compensate for uncertainty in the first position indication and thereby produce a position estimate.

2. The navigation system as recited in claim 1 wherein the processor applies a recursive data processing algorithm to the first, second and third position indications.

3. The navigation system as recited in claim 1 wherein the processor applies a Kalman filter to the first, second and third position indications.

4. The navigation system as recited in claim 1 wherein:
the first set of data from the first receiver is employed to produce a first velocity value;
the second set of data from the second receiver is employed to produce a second velocity value; and
the processor employs the second velocity value to compensate for uncertainty in the first velocity value and thereby produce a velocity estimate.

5. The navigation system as recited in claim 4 wherein the processor employs a recursive data processing algorithm to the first, second and third position indications and to the first and second velocity values.

6. The navigation system as recited in claim 4 wherein the processor applies a Kalman filter to the first, second and third position indications and to the first and second velocity values.

7. The navigation system as recited in claim 1 further comprising a database of information related to distance measuring equipment stations within a geographical area; and a mechanism that selects, from the database, the plurality of distance measuring equipment stations and tunes the second receiver to each one of the plurality of distance measuring equipment stations.

8. A navigation method for a vehicle comprising:
providing an inertial reference system onboard the vehicle which produces a first set of data;
deriving a first position indication from the first set of data;
receiving, via a receiver onboard the vehicle, signals of a global positioning system and in response thereto producing a second set of data;
deriving a second position indication from the second set of data;
receiving, via a transceiver onboard the vehicle, signals from a plurality of distance measuring equipment stations at fixed positions on the earth and in response thereto producing a third set of data denoting distances between the vehicle and each distance measuring equipment station;
deriving a third position indication from the second third of data; and
employing the second and third position indications in a processor to compensate for uncertainty in the first position indication and thereby produce a position estimate.

9. The navigation method as recited in claim 8 wherein employing the second and third position indications applies a Kalman filter function to the first, second and third position indications.

10. The navigation method as recited in claim 8 further comprising:
deriving a first velocity value from the first set of data;
deriving a second velocity value from the second set of data; and
employing the second velocity value in the processor to compensate for uncertainty in the first velocity value and thereby produce a velocity estimate.

11. The navigation method as recited in claim 10 wherein employing the second velocity value applies a Kalman filter function to the first and second velocity values.

12. The navigation method as recited in claim 8 wherein receiving signals from a plurality of distance measuring equipment stations comprises sequentially tuning the transceiver to each of the plurality of distance measuring equipment stations and transmitting an interrogation signal.

13. A navigation method for a vehicle comprising:
providing an inertial reference system onboard the vehicle which produces a first position indication and a first velocity value;
receiving, onboard the vehicle, signals of a global positioning system and in response thereto producing a second position indication and a second velocity value;
receiving, onboard the vehicle, signals from a plurality of distance measuring equipment stations at fixed positions on the earth and in response thereto producing a third position indication; and
applying a Kalman filter function to the first, second, and third position indications and to the first and second velocity values to compensate for uncertainty in the first position indication and in the first velocity value and thereby produce a vehicle position estimate and a vehicle velocity estimate.

14. The navigation method as recited in claim 13 wherein receiving signals from a plurality of distance measuring equipment stations comprises sequentially tuning a transceiver to each such station, transmitting an interrogation signal to each such station, and receiving a reply signal.

15. The navigation method as recited in claim 13 wherein receiving signals from a plurality of distance measuring equipment stations further comprises determining from those signals distances between the vehicle and each distance measuring equipment station; and deriving the third position indication from the distances.
